(19) United States
(12) Patent Application Publication
(10) Pub. No.: US 2007/0197120 A1
(43) Pub. Date: Aug. 23, 2007

(54) Substrate adhesion apparatus and method for sealing organic light emitting display using the same

(76) Inventor: Jong Woo Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/529,883

(22) Filed: Sep. 29, 2006

(30) Foreign Application Priority Data
Feb. 20, 2006 (KR) 10-2006-0016446

(51) Int. Cl. H01J 9/26; H01J 9/46; H05B 33/10

(52) U.S. Cl. 445/25; 445/66

(57) ABSTRACT

A substrate adhesion apparatus and method for sealing an organic light emitting display using the same. Two substrates to be adhered to each other are engaged using uniform air pressure provided by a plate. The plate includes an air introduction hole, a plurality of discharge holes, a groove, and an elastic member, the plurality of discharge holes being formed at an upper surface of the positioning plate, the discharge holes communicating with the air suction hole for discharging introduced air, the groove being formed to enclose the discharge holes in a rectangular pattern, and the elastic member being inserted into the groove with at least a part of the elastic member protruding to an outside of the groove in a state that external pressure is not applied to the elastic member. A shaft is mounted at a lower surface of the positioning plate for supporting and moving the positioning plate.

### CROSS-REFERENCE TO RELATED APPLICATIONS

This application claims the benefit of Korean Patent Application No. 10-2006-0016446, filed on Feb. 20, 2006, in the Korean Intellectual Property Office, the disclosure of which is incorporated herein by reference in its entirety.

### BACKGROUND

1. Field

The invention relates to an apparatus and a method for sealing an organic light emitting display using the same.

2. Discussion of the Related Technology

An organic light emitting display is a kind of planar display, which emits light. Excited molecules generated by combined holes and electrons return to a base state to emit the energy. By applying a voltage to two electrodes facing each other where an organic emission layer is disposed between the two electrodes, holes and electrons injected from respective electrodes recombine, resulting in light emission from the organic emission layer.

An organic light emitting display having excellent light-emission, a wide angle of visibility, and a high-speed response has been proposed as the next-generation planar type display devices.

However, when moisture or oxygen from an ambient environment is introduced to one or more organic light emitting diodes included in the organic light emitting display, the life of such an organic light emitting display is reduced, emission efficiency is deteriorated, and emission color changes, e.g., due to oxidation of electrode material and peeling.

In order to solve the aforementioned problems, at least a pixel region having the organic light emitting diodes is sealed. For example, a sealing substrate on which absorbent and epoxy are coated is joined with a deposition substrate on which the pixel region is arranged so as to be overlapped with the pixel region. After the two substrates are adhered to each other, the epoxy is melted and cured through sintering or ultra-violet irradiation to stick the two substrates to each other, thereby sealing the pixel region. The above discussion is simply to describe the general field of organic light emitting displays and is not a discussion of prior art.

### SUMMARY OF CERTAIN INVENTIVE ASPECTS

It is important to stick the two substrates to each other by means of uniform force. The reason is that a part applied by a relatively smaller force can fail to seal properly or be easily separated after sealing when the two substrates are not adhered to each other properly. However, conventionally, after a sealing substrate is positioned on a substrate stage, epoxy is coated at an edge of the sealing substrate not to be overlapped with a pixel region. A deposition substrate in which the pixel region is formed is arranged at an upper portion of the sealing substrate. The two substrates are adhered to each other either by only a weight of the deposition substrate or by using a shaft operated by a motor or the force of a spring. However, when two substrates are adhered to each other by only a weight of the deposition substrate, the relative weights of a pixel region and a non-pixel region may be different from each other. A droop or sliding can occur, with the result that sealing between two substrates is not uniform. Further, when the motor or the force of a spring is used, a force of a shaft part of the motor can be operated greater than other parts. Since an elastic force of the spring can have a deflection, sealing between two substrates is not necessarily uniform.

For example, U.S. Pat. No. 6,998,776 discloses a structure of sealing a pixel region of a deposition substrate by coating a frit at a glass substrate without adsorbents. In U.S. Pat. No. 6,998,776, because curing the melted frit seals between a first substrate and a second substrate, it causes the organic light emitting display to be efficiently protected without adsorbents. However, when frit is used to seal a pixel region, in arranging a sealing substrate on which frit is coated on a deposition substrate in which a pixel region is formed and adhering the two substrates to each other, a droop or a sliding of the substrates can occur. This reduces less alignment and can cause adhesion between the two substrates to become less uniform. Parts applied by a relatively smaller force can fail to seal properly or be easily separated after sealing.

Accordingly, it is an aspect of the invention to provide a substrate adhesion apparatus and a method for sealing an organic light emitting display using the same, which more uniformly adheres two substrates to each other using uniform air pressure/vacuum provided by plates.

The foregoing and/or other aspects of the invention are achieved by providing a substrate adhesion apparatus comprising a positioning plate including an air introduction hole, a plurality of discharge holes, a groove, and an elastic member, the plurality of discharge holes being formed at an upper surface of the positioning plate, the discharge holes communicating with the air introduction hole and arranged for discharging introduced air, the groove being formed to extend around the discharge holes in a generally rectangular pattern, and the elastic member being inserted into the groove with at least a part of the elastic member protruding to an outside of the groove in a state that an external pressure is not applied to the elastic member and a shaft mounted at a lower surface of the positioning plate for supporting and moving the positioning plate, wherein the shaft moves the positioning plate up and down after a first substrate is positioned on the elastic member of the positioning plate.

A closed space can be formed between the positioning plate and the first substrate, by an elastic member a relaxed shape of which is restored, when the air introduced through the air introduction hole is discharged to the discharge holes. The apparatus can further include a substrate holder for supporting a second substrate arranged to face the first substrate. A conduit can be connected between the air introduction hole and the discharge holes inside the positioning plate. In addition, an upper portion of the groove can be made narrower than a lower portion of the groove. In one embodiment, the elastic member is made of rubber.

According to another aspect of the invention, there is provided a substrate adhesion apparatus comprising a first plate including an air introduction hole, a plurality of discharge holes, a groove, and an elastic member, the plurality of discharge holes being formed at one surface of the first plate, and communicating with the air introduction hole for discharging introduced air, the groove being formed to enclose the discharge holes in a generally rectangular pattern, and the elastic member being inserted into the groove such that at least a part of the elastic member protruded to an outside of the groove in a state that an external pressure is not applied to the elastic member, a first shaft mounted at another surface of the first plate for supporting and moving the first plate, a second plate disposed to face the first plate, a plurality of air suction holes being formed at one surface of the second plate to face the first plate so that air is sucked into an inside of the second plate, the second plate including at least one discharge hole communicating with the suction holes for discharging sucked air, and a second shaft mounted at another surface of the second plate for supporting and moving the second plate.

A movement of the first shaft adheres the first substrate and the second substrate positioned between the first and second plates to each other. The discharge holes can be connected to an air suction device. The air suction device can be a vacuum pump.

According to an aspect of the invention, there is provided a method for sealing an organic light emitting display, comprising positioning a first substrate on a positioning plate so as to be overlapped with an elastic member, the positioning plate including an air introduction hole, a plurality of discharge holes, and an elastic member, the plurality of discharge holes communicating with the air introduction hole, and the elastic member being inserted into a groove formed in the positioning plate and arranged to enclose the discharge holes, arranging a second substrate to be aligned with an upper portion of the first substrate, forming sealant on at least one of the first and second substrates, introducing air between the positioning plate and the first substrate through the air introduction hole to maintain a predetermined air pressure, moving the positioning plate up and down to adhere the first and second substrates to each other, and irradiating a region corresponding to the sealant to join the first and second substrates to each other.

The first substrate can include a pixel region and a non-pixel region formed at a periphery of the pixel region, and the second substrate is arranged to be overlapped with the pixel region and a part of non-pixel region. Sealant can be arranged to be overlapped with the non-pixel region, and the sealant can be a frit. In coating, sintering, and curing a frit paste on the second substrate to form the frit, the frit paste can include an absorbent absorbing the laser or the infrared ray, and the frit paste can be sintered at a temperature ranging from 300° C. to 700° C. In addition, the frit can be stuck to the first and second substrates by absorbing the laser or the infrared ray and melting. Further, a patterned mask can be arranged on the second substrate corresponding to the sealant. Moreover, a wavelength of the laser or the infrared ray can range from 800 nm to 1200 nm.

Other embodiments include an apparatus for engaging two substrates, the apparatus comprising a first plate having a substantially planar support surface and adapted to provide a substantially uniform positive pressure across the support surface, an elastic member arranged about a periphery of the support surface and such that, in a relaxed state, the elastic member extends partially above the support surface and that, under weight of a substrate placed upon the elastic member, the elastic member deforms to provide a pressurized region under the substrate, within the elastic member, and above the support surface, a second plate having a substantially planar support surface and adapted to provide a substantially uniform negative pressure across the support surface, and at least a first support shaft engaged with at least one of the first and second support plates such that the at least first support shaft induces the first and second support plates into and away from adjacency with each other.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a cross-sectional view showing a substrate adhesion apparatus according to a first embodiment of the invention;

FIG. 2 is a plan view showing a positioning plate shown in FIG. 1;

FIG. 3a to FIG. 3e are cross-sectional views that illustrate a method for sealing an organic light emitting display using the substrate adhesion apparatus shown in FIG. 1;

FIG. 4 is a cross-sectional view showing a method for sealing an organic light emitting display in sheet unit using the substrate adhesion apparatus shown in FIG. 1;

FIG. 5 is a cross-sectional view showing a substrate adhesion apparatus according to a second embodiment of the invention;

FIG. 6 is a plan view showing a second plate shown in FIG. 5; and

FIG. 7 is a cross-sectional view that illustrates a method for sealing an organic light emitting display using the substrate adhesion apparatus shown in FIG. 5.

FIG. 8 is a schematic exploded view of a passive matrix type organic light emitting display device in accordance with one embodiment.

FIG. 9 is a schematic exploded view of an active matrix type organic light emitting display device in accordance with one embodiment.

FIG. 10 is a schematic top plan view of an organic light emitting display in accordance with one embodiment.

FIG. 11 is a cross-sectional view of the organic light emitting display of FIG. 10, taken along the line 11-11.

FIG. 12 is a schematic perspective view illustrating mass production of organic light emitting devices in accordance with one embodiment.

### DETAILED DESCRIPTION OF CERTAIN EMBODIMENTS

Hereinafter, embodiments according to the invention will be described with reference to the accompanying drawings. Here, when one element is connected to another element, one element may be not only directly connected to another element but also indirectly connected to another element via another element. In addition, like reference numerals refer to like elements throughout.

An organic light emitting display (OLED) is a display device comprising an array of organic light emitting diodes. Organic light emitting diodes are solid state devices which include an organic material and are adapted to generate and emit light when appropriate electrical potentials are applied.

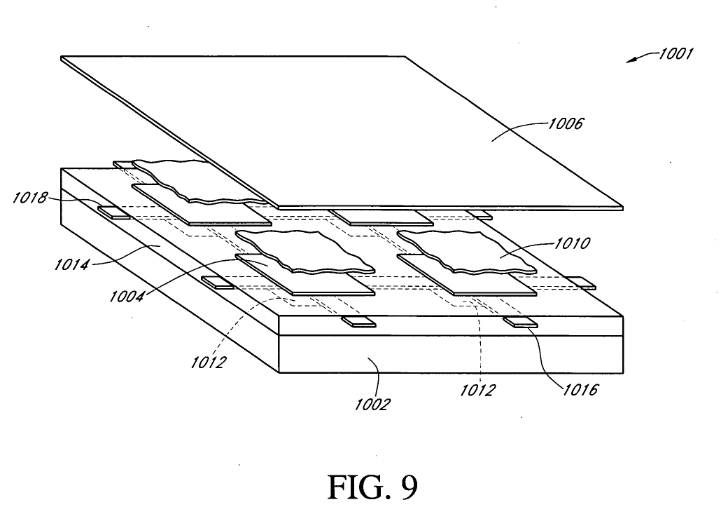

OLEDs can be generally grouped into two basic types dependent on the arrangement with which the stimulating electrical current is provided. FIG. 8 schematically illustrates an exploded view of a simplified structure of a passive matrix type OLED 1000. FIG. 9 schematically illustrates a simplified structure of an active matrix type OLED 1001. In both configurations, the OLED 1000, 1001 includes OLED pixels built over a substrate 1002, and the OLED pixels include an anode 1004, a cathode 1006 and an organic layer 1010. When an appropriate electrical current is applied to the anode 1004, electric current flows through the pixels and visible light is emitted from the organic layer.

Referring to FIG. 8, the passive matrix OLED (PMOLED) design includes elongate strips of anode 1004 arranged generally perpendicular to elongate strips of cathode 1006 with organic layers interposed therebetween. The intersections of the strips of cathode 1006 and anode 1004 define individual OLED pixels where light is generated and emitted upon appropriate excitation of the corresponding strips of anode 1004 and cathode 1006. PMOLEDs provide the advantage of relatively simple fabrication.

Referring to FIG. 9, the active matrix OLED (AMOLED) includes local driving circuits 1012 arranged between the substrate 1002 and an array of OLED pixels. An individual pixel of AMOLEDs is defined between the common cathode 1006 and an anode 1004, which is electrically isolated from other anodes. Each driving circuit 1012 is coupled with an anode 1004 of the OLED pixels and further coupled with a data line 1016 and a scan line 1018. In embodiments, the scan lines 1018 supply scan signals that select rows of the driving circuits, and the data lines 1016 supply data signals for particular driving circuits. The data signals and scan signals stimulate the local driving circuits 1012, which excite the anodes 1004 so as to emit light from their corresponding pixels.

In the illustrated AMOLED, the local driving circuits 1012, the data lines 1016 and scan lines 1018 are buried in a planarization layer 1014, which is interposed between the pixel array and the substrate 1002. The planarization layer 1014 provides a planar top surface on which the organic light emitting pixel array is formed. The planarization layer 1014 may be formed of organic or inorganic materials, and formed of two or more layers although shown as a single layer. The local driving circuits 1012 are typically formed with thin film transistors (TFT) and arranged in a grid or array under the OLED pixel array. The local driving circuits 1012 may be at least partly made of organic materials, including organic TFT. AMOLEDs have the advantage of fast response time improving their desirability for use in displaying data signals. Also, AMOLEDs have the advantages of consuming less power than passive matrix OLEDs.

Referring to common features of the PMOLED and AMOLED designs, the substrate 1002 provides structural support for the OLED pixels and circuits. In various embodiments, the substrate 1002 can comprise rigid or flexible materials as well as opaque or transparent materials, such as plastic, glass, and/or foil. As noted above, each OLED pixel or diode is formed with the anode 1004, cathode 1006 and organic layer 1010 interposed therebetween. When an appropriate electrical current is applied to the anode 1004, the cathode 1006 injects electrons and the anode 1004 injects holes. In certain embodiments, the anode 1004 and cathode 1006 are inverted; i.e., the cathode is formed on the substrate 1002 and the anode is opposingly arranged.

Interposed between the cathode 1006 and anode 1004 are one or more organic layers. More specifically, at least one emissive or light emitting layer is interposed between the cathode 1006 and anode 1004. The light emitting layer may comprise one or more light emitting organic compounds. Typically, the light emitting layer is configured to emit visible light in a single color such as blue, green, red or white. In the illustrated embodiment, one organic layer 1010 is formed between the cathode 1006 and anode 1004 and acts as a light emitting layer. Additional layers, which can be formed between the anode 1004 and cathode 1006, can include a hole transporting layer, a hole injection layer, an electron transporting layer and an electron injection layer.

Hole transporting and/or injection layers can be interposed between the light emitting layer 1010 and the anode 1004. Electron transporting and/or injecting layers can be interposed between the cathode 1006 and the light emitting layer 1010. The electron injection layer facilitates injection of electrons from the cathode 1006 toward the light emitting layer 1010 by reducing the work function for injecting electrons from the cathode 1006. Similarly, the hole injection layer facilitates injection of holes from the anode 1004 toward the light emitting layer 1010. The hole and electron transporting layers facilitate movement of the carriers injected from the respective electrodes toward the light emitting layer.

In some embodiments, a single layer may serve both electron injection and transportation functions or both hole injection and transportation functions. In some embodiments, one or more of these layers are lacking. In some embodiments, one or more organic layers are doped with one or more materials that help injection and/or transportation of the carriers. In embodiments where only one organic layer is formed between the cathode and anode, the organic layer may include not only an organic light emitting compound but also certain functional materials that help injection or transportation of carriers within that layer.

There are numerous organic materials that have been developed for use in these layers including the light emitting layer. Also, numerous other organic materials for use in these layers are being developed. In some embodiments, these organic materials may be macromolecules including oligomers and polymers. In some embodiments, the organic materials for these layers may be relatively small molecules. The skilled artisan will be able to select appropriate materials for each of these layers in view of the desired functions of the individual layers and the materials for the neighboring layers in particular designs.

In operation, an electrical circuit provides appropriate potential between the cathode 1006 and anode 1004. This results in an electrical current flowing from the anode 1004 to the cathode 1006 via the interposed organic layer(s). In one embodiment, the cathode 1006 provides electrons to the adjacent organic layer 1010. The anode 1004 injects holes to the organic layer 1010. The holes and electrons recombine in the organic layer 1010 and generate energy particles called “excitons.” The excitons transfer their energy to the organic light emitting material in the organic layer 1010, and the energy is used to emit visible light from the organic light emitting material. The spectral characteristics of light generated and emitted by the OLED 1000, 1001 depend on the nature and composition of organic molecules in the organic layer(s). The composition of the one or more organic layers can be selected to suit the needs of a particular application by one of ordinary skill in the art.

OLED devices can also be categorized based on the direction of the light emission. In one type referred to as “top emission” type, OLED devices emit light and display images through the cathode or top electrode 1006. In these embodiments, the cathode 1006 is made of a material transparent or at least partially transparent with respect to visible light. In certain embodiments, to avoid losing any light that can pass through the anode or bottom electrode 1004, the anode may be made of a material substantially reflective of the visible light. A second type of OLED devices emits light through the anode or bottom electrode 1004 and is called “bottom emission” type. In the bottom emission type OLED devices, the anode 1004 is made of a material which is at least partially transparent with respect to visible light. Often, in bottom emission type OLED devices, the cathode 1006 is made of a material substantially reflective of the visible light. A third type of OLED devices emits light in two directions, e.g. through both anode 1004 and cathode 1006. Depending upon the direction(s) of the light emission, the substrate may be formed of a material which is transparent, opaque or reflective of visible light.

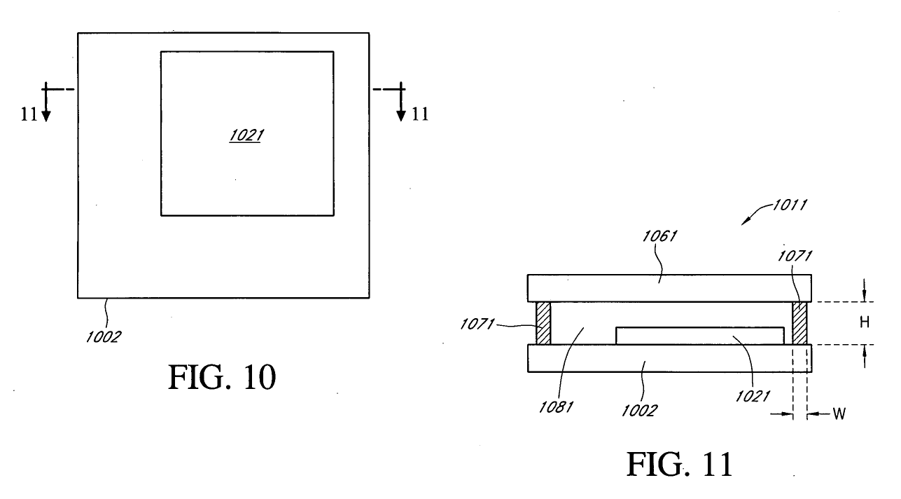

In many embodiments, an OLED pixel array 1021 comprising a plurality of organic light emitting pixels is arranged over a substrate 1002 as shown in FIG. 10. In embodiments, the pixels in the array 1021 are controlled to be turned on and off by a driving circuit (not shown), and the plurality of the pixels as a whole displays information or image on the array 1021. In certain embodiments, the OLED pixel array 1021 is arranged with respect to other components, such as drive and control electronics to define a display region and a non-display region. In these embodiments, the display region refers to the area of the substrate 1002 where OLED pixel array 1021 is formed. The non-display region refers to the remaining areas of the substrate 1002. In embodiments, the non-display region can contain logic and/or power supply circuitry. It will be understood that there will be at least portions of control/drive circuit elements arranged within the display region. For example, in PMOLEDs, conductive components will extend into the display region to provide appropriate potential to the anode and cathodes. In AMOLEDs, local driving circuits and data/scan lines coupled with the driving circuits will extend into the display region to drive and control the individual pixels of the AMOLEDs.

One design and fabrication consideration in OLED devices is that certain organic material layers of OLED devices can suffer damage or accelerated deterioration from exposure to water, oxygen or other harmful gases. Accordingly, it is generally understood that OLED devices be sealed or encapsulated to inhibit exposure to moisture and oxygen or other harmful gases found in a manufacturing or operational environment. FIG. 11 schematically illustrates a cross-section of an encapsulated OLED device 1011 having a layout of FIG. 10 and taken along the line 11-11 of FIG. 10. In this embodiment, a generally planar top plate or substrate 1061 engages with a seal 1071 which further engages with a bottom plate or substrate 1002 to enclose or encapsulate the OLED pixel array 1021. In other embodiments, one or more layers are formed on the top plate 1061 or bottom plate 1002, and the seal 1071 is coupled with the bottom or top substrate 1002, 1061 via such a layer. In the illustrated embodiment, the seal 1071 extends along the periphery of the OLED pixel array 1021 or the bottom or top plate 1002, 1061.

In embodiments, the seal 1071 is made of a frit material as will be further discussed below. In various embodiments, the top and bottom plates 1061, 1002 comprise materials such as plastics, glass and/or metal foils which can provide a barrier to passage of oxygen and/or water to thereby protect the OLED pixel array 1021 from exposure to these substances. In embodiments, at least one of the top plate 1061 and the bottom plate 1002 are formed of a substantially transparent material.

To lengthen the life time of OLED devices 1011, it is generally desired that seal 1071 and the top and bottom plates 1061, 1002 provide a substantially non-permeable seal to oxygen and water vapor and provide a substantially hermetically enclosed space 1081. In certain applications, it is indicated that the seal 1071 of a frit material in combination with the top and bottom plates 1061, 1002 provide a barrier to oxygen of less than approximately 10⁻³ cc/m²-day and to water of less than 10⁻⁶ g/m²-day. Given that some oxygen and moisture can permeate into the enclosed space 1081, in some embodiments, a material that can take up oxygen and/or moisture is formed within the enclosed space 1081.

The seal 1071 has a width W, which is its thickness in a direction parallel to a surface of the top or bottom substrate 1061, 1002 as shown in FIG. 11. The width varies among embodiments and ranges from about 300 μm to about 3000 μm, optionally from about 500 μm to about 1500 μm. Also, the width may vary at different positions of the seal 1071. In some embodiments, the width of the seal 1071 may be the largest where the seal 1071 contacts one of the bottom and top substrate 1002, 1061 or a layer formed thereon. The width may be the smallest where the seal 1071 contacts the other. The width variation in a single cross-section of the seal 1071 relates to the cross-sectional shape of the seal 1071 and other design parameters.

The seal 1071 has a height H, which is its thickness in a direction perpendicular to a surface of the top or bottom substrate 1061, 1002 as shown in FIG. 11. The height varies among embodiments and ranges from about 2 μm to about 30 μm, optionally from about 10 μm to about 15 μm. Generally, the height does not significantly vary at different positions of the seal 1071. However, in certain embodiments, the height of the seal 1071 may vary at different positions thereof.

In the illustrated embodiment, the seal 1071 has a generally rectangular cross-section. In other embodiments, however, the seal 1071 can have other various cross-sectional shapes such as a generally square cross-section, a generally trapezoidal cross-section, a cross-section with one or more rounded edges, or other configuration as indicated by the needs of a given application. To improve hermeticity, it is generally desired to increase the interfacial area where the seal 1071 directly contacts the bottom or top substrate 1002, 1061 or a layer formed thereon. In some embodiments, the shape of the seal can be designed such that the interfacial area can be increased.

The seal 1071 can be arranged immediately adjacent the OLED array 1021, and in other embodiments, the seal 1071 is spaced some distance from the OLED array 1021. In certain embodiment, the seal 1071 comprises generally linear segments that are connected together to surround the OLED array 1021. Such linear segments of the seal 1071 can extend, in certain embodiments, generally parallel to respective boundaries of the OLED array 1021. In other embodiment, one or more of the linear segments of the seal 1071 are arranged in a non-parallel relationship with respective boundaries of the OLED array 1021. In yet other embodiments, at least part of the seal 1071 extends between the top plate 1061 and bottom plate 1002 in a curvilinear manner.

As noted above, in certain embodiments, the seal 1071 is formed using a frit material or simply “frit” or glass frit, which includes fine glass particles. The frit particles includes one or more of magnesium oxide (MgO), calcium oxide (CaO), barium oxide (BaO), lithium oxide (Li₂O), sodium oxide (Na₂O), potassium oxide (K₂O), boron oxide (B₂O₃), vanadium oxide (V₂O₅), zinc oxide (ZnO), tellurium oxide (TeO₂), aluminum oxide (Al₂O₃), silicon dioxide (SiO₂), lead oxide (PbO), tin oxide (SnO), phosphorous oxide (P₂O₅), ruthenium oxide (Ru₂O), rubidium oxide (Rb₂O), rhodium oxide (Rh₂O), ferrite oxide (Fe₂O₃), copper oxide (CuO), titanium oxide (TiO₂), tungsten oxide (WO₃), bismuth oxide (Bi₂O₃), antimony oxide (Sb₂O₃), lead-borate glass, tin-phosphate glass, vanadate glass, and borosilicate, etc. In embodiments, these particles range in size from about 2 μm to about 30 μm, optionally about 5 μm to about 10 μm, although not limited only thereto. The particles can be as large as about the distance between the top and bottom substrates 1061, 1002 or any layers formed on these substrates where the frit seal 1071 contacts.

The frit material used to form the seal 1071 can also include one or more filler or additive materials. The filler or additive materials can be provided to adjust an overall thermal expansion characteristic of the seal 1071 and/or to adjust the absorption characteristics of the seal 1071 for selected frequencies of incident radiant energy. The filler or additive material(s) can also include inversion and/or additive fillers to adjust a coefficient of thermal expansion of the frit. For example, the filler or additive materials can include transition metals, such as chromium (Cr), iron (Fe), manganese (Mn), cobalt (Co), copper (Cu), and/or vanadium. Additional materials for the filler or additives include ZnSiO₄, PbTiO₃, ZrO₂, eucryptite.

In embodiments, a frit material as a dry composition contains glass particles from about 20 to 90 about wt %, and the remaining includes fillers and/or additives. In some embodiments, the frit paste contains about 10-30 wt % organic materials and about 70-90% inorganic materials. In some embodiments, the frit paste contains about 20 wt % organic materials and about 80 wt % inorganic materials. In some embodiments, the organic materials may include about 0-30 wt % binder(s) and about 70-100 wt % solvent(s). In some embodiments, about 10 wt % is binder(s) and about 90 wt % is solvent(s) among the organic materials. In some embodiments, the inorganic materials may include about 0-10 wt % additives, about 20-40 wt % fillers and about 50-80 wt % glass powder. In some embodiments, about 0-5 wt % is additive(s), about 25-30 wt % is filler(s) and about 65-75 wt % is the glass powder among the inorganic materials.

In forming a frit seal, a liquid material is added to the dry flit material to form a frit paste. Any organic or inorganic solvent with or without additives can be used as the liquid material. In embodiments, the solvent includes one or more organic compounds. For example, applicable organic compounds are ethyl cellulose, nitro cellulose, hydroxyl propyl cellulose, butyl carbitol acetate, terpineol, butyl cellusolve, acrylate compounds. Then, the thus formed frit paste can be applied to form a shape of the seal 1071 on the top and/or bottom plate 1061, 1002.

In one exemplary embodiment, a shape of the seal 1071 is initially formed from the frit paste and interposed between the top plate 1061 and the bottom plate 1002. The seal 1071 can in certain embodiments be pre-cured or pre-sintered to one of the top plate and bottom plate 1061, 1002. Following assembly of the top plate 1061 and the bottom plate 1002 with the seal 1071 interposed therebetween, portions of the seal 1071 are selectively heated such that the frit material forming the seal 1071 at least partially melts. The seal 1071 is then allowed to resolidify to form a secure joint between the top plate 1061 and the bottom plate 1002 to thereby inhibit exposure of the enclosed OILED pixel array 1021 to oxygen or water.

In embodiments, the selective heating of the frit seal is carried out by irradiation of light, such as a laser or directed infrared lamp. As previously noted, the frit material forming the seal 1071 can be combined with one or more additives or filler such as species selected for improved absorption of the irradiated light to facilitate heating and melting of the frit material to form the seal 1071.

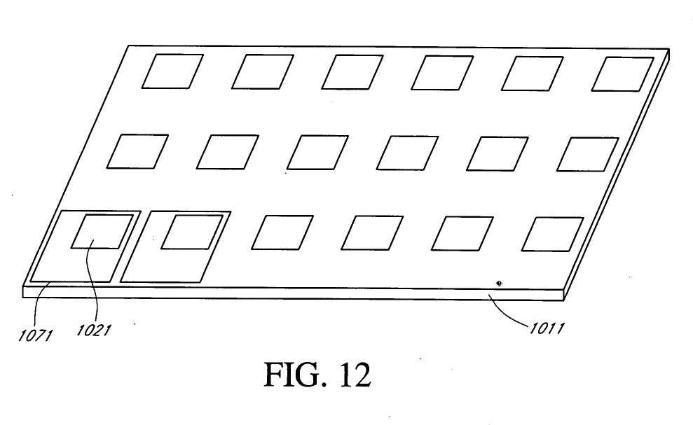

In some embodiments, OLED devices 1011 are mass produced. In an embodiment illustrated in FIG. 12, a plurality of separate OLED arrays 1021 is formed on a common bottom substrate 1101. In the illustrated embodiment, each OLED array 1021 is surrounded by a shaped frit to form the seal 1071. In embodiments, common top substrate (not shown) is placed over the common bottom substrate 1101 and the structures formed thereon such that the OLED arrays 1021 and the shaped frit paste are interposed between the common bottom substrate 1101 and the common top substrate. The OLED arrays 1021 are encapsulated and sealed, such as via the previously described enclosure process for a single OLED display device. The resulting product includes a plurality of OLED devices kept together by the common bottom and top substrates. Then, the resulting product is cut into a plurality of pieces, each of which constitutes an OLED device 1011 of FIG. 11. In certain embodiments, the individual OLED devices 1011 then further undergo additional packaging operations to further improve the sealing formed by the frit seal 1071 and the top and bottom substrates 1061, 1002.

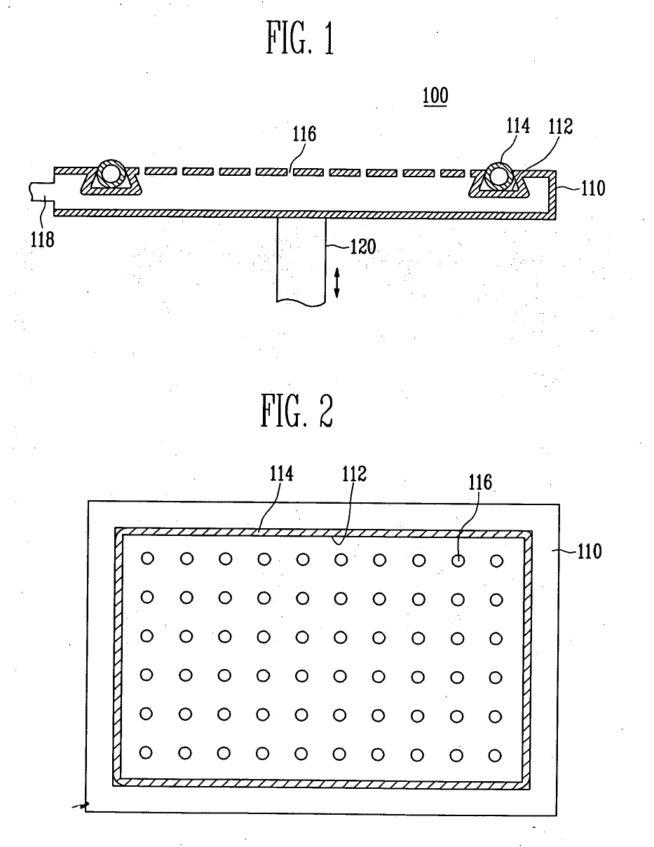

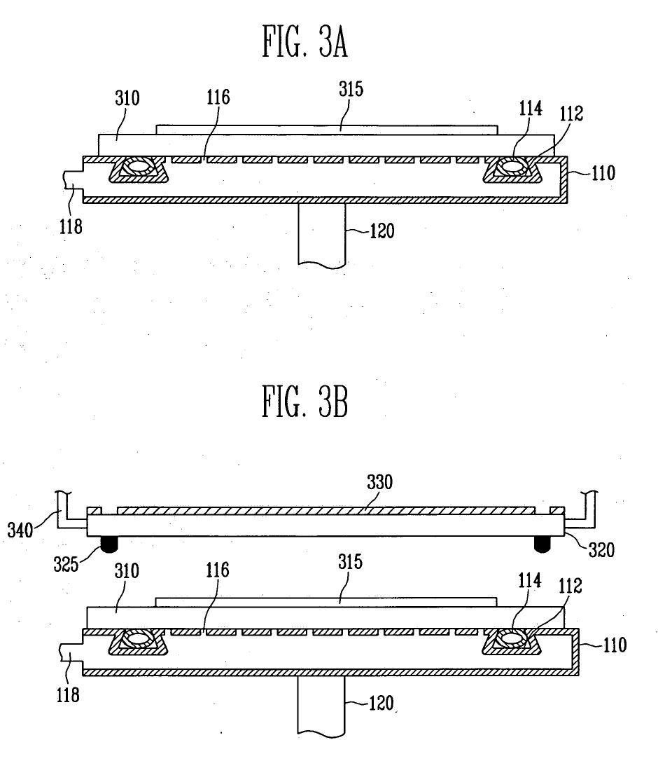

FIG. 1 is a cross-sectional view showing a substrate adhesion apparatus 100 according to an embodiment of the invention. FIG. 2 is a plan view showing a positioning plate 100 shown in FIG. 1.

With reference to FIG. 1 and FIG. 2, the substrate adhesion apparatus 100 includes the positioning plate 110 and a shaft 120. The shaft 120 is fixed to one surface of the positioning plate 110.

A space is formed inside the positioning plate 110 to have air therein. A plurality of discharge holes 116 are formed at an upper surface of the positioning plate 110. Air is discharged through the discharge holes 116. Here, although the space is formed inside the positioning plate 110, a conduit can be formed inside the positioning plate 110 to communicate an air introduction hole 118 with the discharge holes 116. In one embodiment, the air introduction hole 118 is formed at one side of the positioning plate 110. The air introduction hole 118 communicates with the discharge holes 116, and injects air into an interior of the positioning plate 110. That is, the positioning plate 110 is configured to discharge the air introduced to the inside through the plurality of discharge holes 116.

A groove 112 is formed at one surface of the positioning plate 110 in which the discharge holes 116 are formed in such a way that the discharge holes 116 are surrounded by the groove 112 in a generally rectangular pattern. An elastic member 114 is inserted into the groove 112. The elastic member 114 is made of elastic material such as rubber. Here, in a state that an external pressure is not applied to the elastic member 114, at least a part thereof protrudes to an outside of the groove 112. An upper portion of the groove 112 is formed to be narrower than a lower portion thereof to inhibit the elastic member 114 from being easily separated therefrom. Herein, the elastic member 114 may be formed in a variety of shapes. For example, the elastic member 114 may have a ring shape. In other embodiments, the elastic member has a generally triangular or trapezoidal cross-section.

The shaft 120 is fixed to another surface of the positioning plate 110. In one embodiment, the shaft is fixed to a lower surface facing a formation surface of the discharge holes 116, and supports and moves the positioning plate 110 up and down.

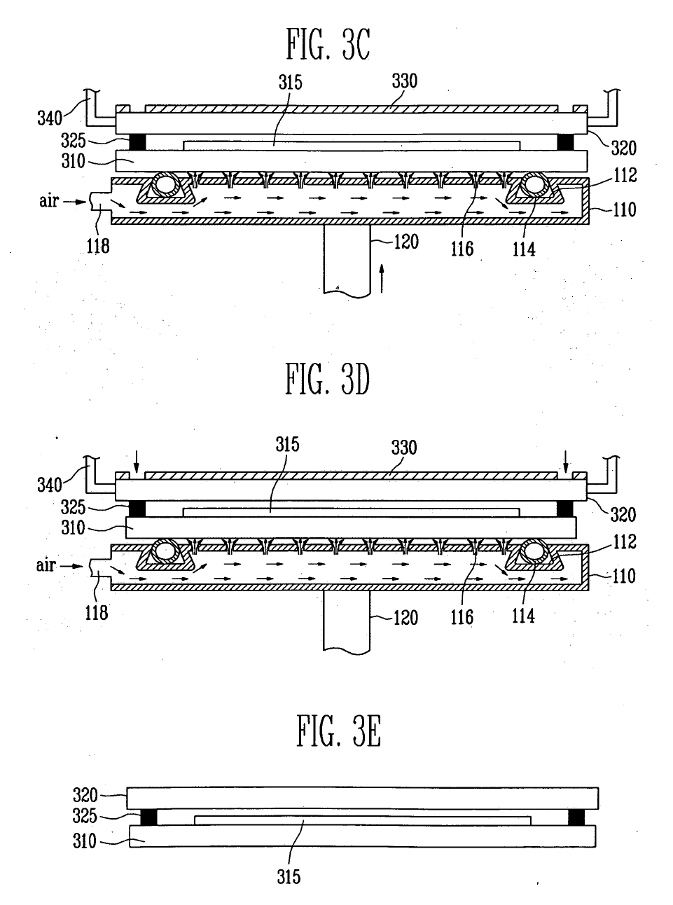

When a substrate (FIGS. 3A-3D) is positioned at the formation surface of the discharge holes 116 in the positioning plate 110, the substrate adhesion apparatus 100 applies substantially uniform pressure to the substrate to move the positioning plate 110 up and down by means of the shaft 120 while maintaining flatness of the substrate. Accordingly, the positioning plate 110 may be used to adhere two substrates to each other when sealing an organic light emitting display. A detailed description thereof will be explained below.

FIG. 3a to FIG. 3e are cross-sectional views that illustrate one embodiment of a method for sealing an organic light emitting display using the substrate adhesion apparatus shown in FIG. 1. FIG. 3a to FIG. 3e show a method for sealing an organic light emitting display by means of a frit compound. However, the invention is not limited thereto. For example, organic light emitting displays can be sealed with epoxy employing embodiments of the invention as described herein.

Referring to FIG. 3a to FIG. 3e, in order to seal the organic light emitting display, a first substrate 310 is positioned on the positioning plate 110 to be overlapped with an elastic member 114 of the positioning plate 110. Herein, the first substrate 310 includes a pixel region 315 and a non-pixel region formed at a periphery of the pixel region 315. Accordingly, the elastic member 114 inserted into the groove 112 of the positioning plate 110 is deformed by a weight of the first substrate 310 to a shape conforming to that of the upper portion of the first substrate 310 to which the elastic member 114 is pressed (FIG. 3a).

Next, by using a robot arm (not shown), the second substrate 320 wherein a sealant 325 is formed an edge thereof, is engaged with an upper portion of the first substrate 310. A substrate holder 340 fixes and supports the second substrate 320. The sealant 325 may be configured by a variety of means. In the embodiment, a frit is used as the sealant 325. In some embodiments, the frit either may be formed by glass materials in a form of a powder having adhesives or melted glass. In one embodiment, the frit includes a glass material, an absorbent, and a filler. The absorbent is adapted to preferentially absorb energy from a laser and the filler reduces a coefficient of thermal expansion.

After a frit paste is coated and sintered on the second substrate 320, moisture or organic binder included in the paste is removed and the resulting object is cured. Here, the frit paste is formed by adding an oxide powder and organic materials to a glass powder to make a gel state. A preferable temperature of sintering the frit ranges from 300° C. to 700° C. In this embodiment, the sintering process substantially retains the organic substance when the sintering temperature of the frit is greater than approximately 300° C. Further, when the sintering temperature of the frit is greater than approximately 700° C., an intensity of a laser beam is increased in proportion to an increase in the sintering temperature. Accordingly, it is not preferred to elevate the sintering temperature greater than approximately 700° C.

The second substrate 320 is arranged at an upper portion of the first substrate 310 to be overlapped with the pixel region 315 and at least a part of the non-pixel region. In one embodiment, the frit 325 is located to be overlapped with the non-pixel region. Since the frit 325 adheres first and second substrates 310 and 320 to each other, a coated surface of the frit 325 is arranged toward the first substrate 310. A patterned mask 330 is arranged on the second substrate 320 to expose the frit 325 part. In one embodiment, in a state that the first and second substrates 310 and 320 are not adhered to each other, the mask 330 is arranged on the second substrate 320. However, after the first and second substrates 310 and 320 are adhered, the mask 330 may be arranged. In this case, the mask 330 has a predetermined weight, and may be fixed by a frame (FIG. 3b).

Air is fed into an inside of the positioning plate 110 through an air injection hole 118, such that the fed air is directed at the first substrate 310 through discharge holes 116. Accordingly, a space is formed between the positioning plate 110 and the first substrate 310 by a pressure of the sprayed air. Because a closed space is formed between the positioning plate 110 and the first substrate 310 by an elastic member 114, the relaxed shape of which is at least partially deformed the entire surface of the first substrate 310 is supported by a substantially uniform air pressure. At this time, air of a predetermined pressure is fed to maintain a contact state between the elastic member 114 and the first substrate 310. In this state, the shaft 120 is transferred to move the positioning plate 110 upward and downward. This leads to an adhesion between the first substrate 310 and the second substrate 320 (FIG. 3C).

In a state that the first and second substrates 310 and 320 are uniformly adhered to each other, a laser or an infrared ray is irradiated to an upper portion of the mask 330 to melt the frit 325. It is preferred that a wavelength of the laser or infrared ray ranges from 800 nm to 1200 nm (more preferably 810 nm), a beam size ranges from approximately 1.0 nm to 3.0 nm in diameter, and an output power ranges from approximately 25 watts to 45 watts (FIG. 3D).

Thereafter, the melted frit 325 is cured and adhered to the first and second substrates 310 and 320, thereby sealing a pixel region 315 and at least a portion of the non-pixel region. Here, the frit 325 seals between the first and second substrates 310 and 320, thereby efficiently inhibiting entrance of oxygen or moisture into the pixel region 315 (FIG. 3e).

In one embodiment for sealing the aforementioned organic light emitting display, the frit 325 is coated on the second substrate 320 to adhere the first and second substrates 310 and 320 to each other. However, the invention is not limited thereto. For example in another embodiment, the frit 325 may be firstly coated on the first substrate 310 in which a pixel region 315 is formed. In another embodiment, the frit 325 is coated both the first substrate 310 and the second substrate 320, thereby adhering the first and second substrates 310 and 320.

FIG. 3a to FIG. 3e show a method for sealing an individual organic light emitting display for convenience, it will be understood by one of ordinary skill that a plurality of organic light emitting display cells may be sealed in sheet unit as shown in FIG. 4

With reference to FIG. 4, the substrate adhesion apparatus 100 of one embodiment more uniformly adheres and seals the first substrate 410 and the second substrate 420 to each other. A plurality of organic light emitting displays having pixel regions 415 are formed on the first substrate 410. Frits 425 are formed at the second substrate 420 corresponding to non-pixel regions. Next, the sealed organic light emitting displays are scribed and divided into a plurality of individual organic light emitting displays. Because a method for sealing the organic light emitting display by the substrate adhesion apparatus 100 according to the embodiments of the invention was described with reference to FIG. 3a to FIG. 3e, a detailed description thereof is omitted.

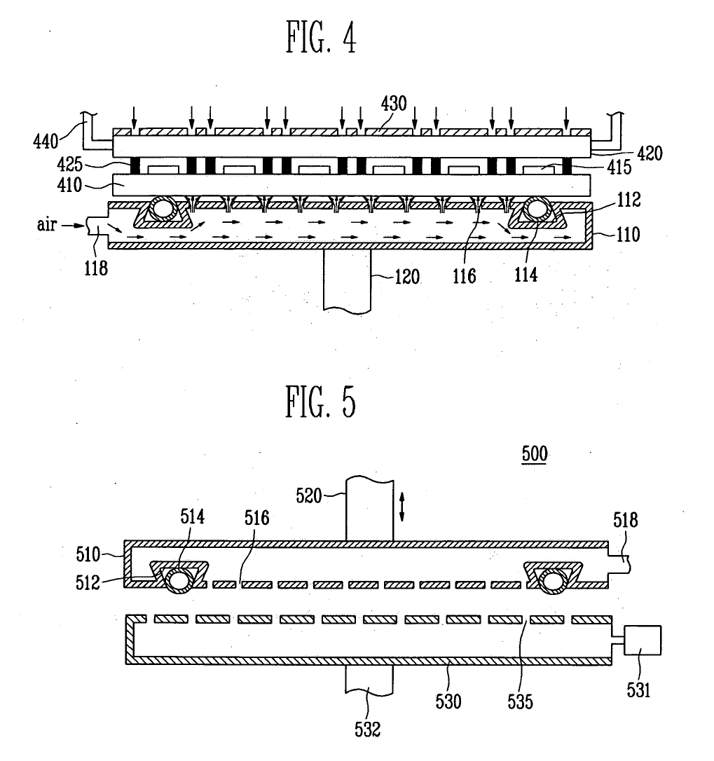

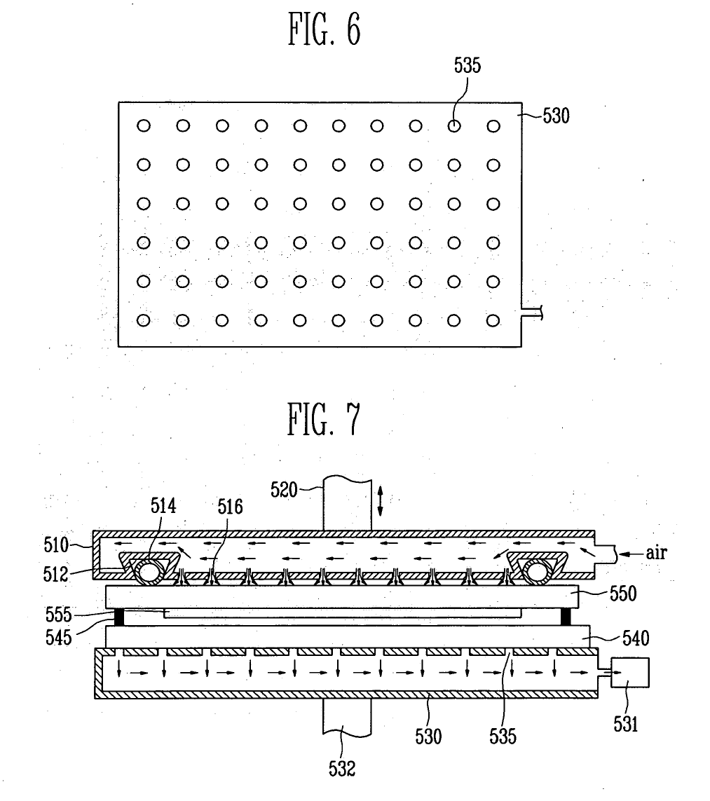

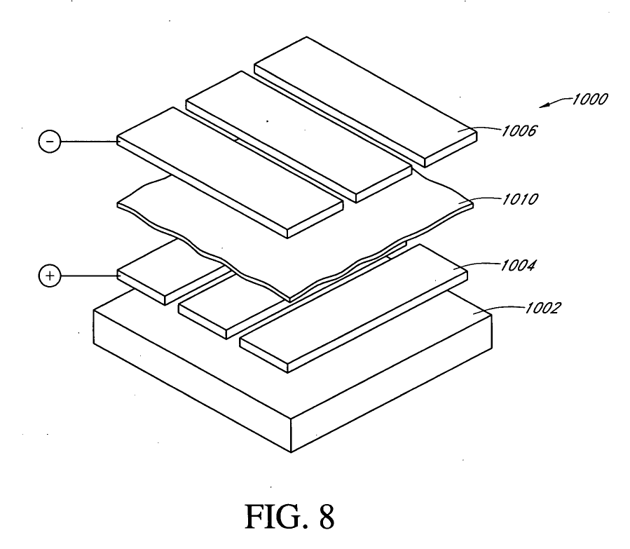

FIG. 5 is a cross-sectional view showing a substrate adhesion apparatus according to another embodiment of the invention. FIG. 6 is a plan view showing a second plate shown in FIG. 5.

Referring to FIG. 5 and FIG. 6, a substrate adhesion apparatus 500 according to another embodiment of the invention includes a first plate 510 and a second plate 530. The first plate 510 is fixed to a first shaft 520. The second plate 530 is disposed to face the first plate 510.

A space is formed inside the first plate 510 to accommodate air therein. A plurality of discharge holes 516 are formed at one surface of the first plate 510, for example, corresponding to the second plate 530. Air is discharged through the discharge holes 516. An air introduction hole 518 is formed at one side of the first plate 510. The air introduction hole 518 communicates with the discharge holes 516, and injects air to an inside of the first plate 510. E.g., the first plate 510 is configured to discharge the air introduced to the inside through the plurality of discharge holes 516.

A groove 512 is formed at one surface of the first plate 510 in which the discharge holes 516 are formed in such a way that the discharge holes 516 are surrounded by the groove 512 in a generally rectangular pattern (FIG. 6). An elastic member 514 is inserted into the groove 512. The elastic member 514 is made of elastic material such as rubber. Here, in a state that an external pressure is not applied to the elastic member 514, at least a part thereof protrudes to an outside of the groove 512. An upper portion of the groove 512 is formed to be narrower than a lower portion thereof to inhibit the elastic member 514 from being easily separated therefrom. Herein, the elastic member 514 may be formed in a variety of shapes. For example, the elastic member 514 may have a ring shape, triangular, trapezoidal, or asymmetric shape.

When the first and second substrates of an organic light emitting display are arranged at a lower portion of the first plate 510, they are moved up and down by a first shaft 520 located at another surface facing a formation surface of the discharge holes 516, thereby applying substantially uniform air pressure to the substrates. This causes the first and second substrates to be more uniformly adhered to each other while maintaining uniformity of the substrates.

The second plate 530 is supported by a second shaft 532. The second plate 530 includes a passage through which air moves. A plurality of suction holes 535 are formed at one surface of the second plate 530 to face the first plate 510, and suck air. The suction holes 535 are connected to an air suction device 531 through a discharge hole communicating with the suction holes 535. The air suction device 531 is disposed, in one embodiment at one side of the second plate 530, and a vacuum pump may be used as the air suction device 531. Accordingly, the air sucked inside the second plate 530 through the suction holes 535, is discharged to the air suction device 531. When a substrate (not shown) is positioned at an upper portion of the second plate 530, air between the second plate 530 and the substrate is sucked to the air suction device 531 through the suction holes 535 of the second plate 530, with the result that the substrate is more firmly held to the second plate 530.

FIG. 7 is a cross-sectional view that illustrates one embodiment of a method for sealing an organic light emitting display using the substrate adhesion apparatus shown in FIGS. 5 and 6. FIG. 7 shows a method for sealing the first and second substrates 540 and 550 of an organic light emitting display using epoxy. However, the invention is not limited thereto.

Referring to FIG. 7, the second substrate 540 having an edge coated by epoxy is positioned on the second plate 530 and air is sucked through suction holes 535, thereby fixing the second substrate 540. Next, the first substrate 550 on which a pixel region is formed is arranged at an upper portion of the second substrate 540, and air is injected inside the first plate 510 to maintain a substantially constant air pressure between the first plate 510 and the first substrate 550. Consequently, the first and second substrates 540 and 550 are more uniformly engaged to each other.

When the first and second substrates 540 and 550 are adjoined to each other, sintering or ultra-violet irradiation melts and cures epoxy 545 to adhere the substrates 540 and 550, thereby sealing the pixel region 555. Since a method for maintaining an air pressure between the first substrate 550 and the first plate 510 was illustrated in the first embodiment, a detailed description thereof will be omitted.

As described earlier, the substrate adhesion apparatus 100 of one embodiment of the invention includes an elastic member 114, a plurality of discharge holes 116, and a plate 110. The elastic member 114 is inserted into a groove 112 enclosing discharge holes 116. The discharge holes 116 are formed at a surface where the first substrate 310 is arranged. The plate 110 includes an air suction hole 118.

Similarly, the substrate adhesion apparatus 500 of this embodiment of the invention includes an elastic member 514, a plurality of discharge holes 516, and a plate 510. The elastic member 514 is inserted into a groove 512 enclosing discharge holes 516. The discharge holes 516 are formed at a surface where the first substrate 550 is arranged. The plate 510 includes an air suction hole 518. In accordance with the aforementioned arrangement, by applying a more uniform air pressure to first and second substrates 310, 320, 540, and 550 of an organic light emitting display of the invention when the first and second substrates 310, 320, 540, and 550 are adhered to each other, a flatness of a substrate is enhanced. This inhibits a droop and a sliding of the substrate and causes the first and second substrates 310, 320, 540, and 550 to be more uniformly adhered to each other while maintaining an aligned state. When the second substrate 540 is positioned at the second plate 530 on which a plurality of suction holes 535, by using the second plate 530, the second substrate 540 is more uniformly engaged with the second plate 530 to stably fix the second substrate 540 with reduced sliding. Owing to the above-mentioned operation, the invention more uniformly seals between two substrates while maintaining an aligned state, which allows a sealing force to be improved.

As apparent from the above description, in a substrate adhesion apparatus and a method for sealing an organic light emitting display using the same in accordance with the invention, by applying a substantially uniform air pressure to first and second substrates of an organic light emitting display when the first and second substrates are engaged with each other, a droop and a sliding of the substrate is inhibited. The first and second substrates are more uniformly adhered to each other while maintaining an aligned state. Owing to this, the invention more uniformly seals between two substrates, which allows a sealing force to be improved.

Although a few embodiments of the invention have been shown and described, it would be appreciated by those skilled in the art that changes might be made in this embodiment without departing from the principles and spirit of the invention, the scope of which is defined in the claims and their equivalents.

What is claimed is:

1. A substrate adhesion apparatus comprising:
a positioning plate including an air introduction hole, a plurality of discharge holes, a groove, and an elastic member, the plurality of discharge holes being formed at an upper surface of the positioning plate, the discharge holes communicating with the air introduction hole and arranged for discharging introduced air, the groove being formed to extend around the discharge holes in a generally rectangular pattern, and the elastic member being inserted into the groove with at least a part of the elastic member protruding to an outside of the groove in a state that an external pressure is not applied to the elastic member; and
a shaft mounted at a lower surface of the positioning plate for supporting and moving the positioning plate, wherein the shaft moves the positioning plate up and down after a first substrate is positioned on the elastic member of the positioning plate.

2. The apparatus as claimed in claim 1, wherein a closed space is formed between the positioning plate and the first substrate, by the elastic member a relaxed shape of which is restored when the air introduced through the air introduction hole is discharged to the discharge holes.

3. The apparatus as claimed in claim 1, further comprising a substrate holder for supporting a second substrate arranged to face the first substrate.

4. The apparatus as claimed in claim 1, comprising a conduit is connected between the air introduction hole and the discharge holes inside the positioning plate.

5. The apparatus as claimed in claim 1, wherein an upper portion of the groove is narrower than a lower portion of the groove.

6. The apparatus as claimed in claim 1, wherein the elastic member comprises rubber.

7. A substrate adhesion apparatus comprising:
a first plate including an air introduction hole, a plurality of discharge holes, a groove, and an elastic member, the plurality of discharge holes being formed at one surface of the first plate, and communicating with the air introduction hole for discharging introduced air, the groove being formed to enclose the discharge holes in a generally rectangular pattern, and the elastic member being inserted into the groove such that at least a part of the elastic member protruded to an outside of the groove in a state that an external pressure is not applied to the elastic member;
a first shaft mounted at another surface of the first plate for supporting and moving the first plate;
a second plate disposed to face the first plate, a plurality of air suction holes being formed at one surface of the second plate to face the first plate so that air is sucked into an inside of the second plate, the second plate including at least one discharge hole communicating with the suction holes for discharging sucked air; and
a second shaft mounted at another surface of the second plate for supporting and moving the second plate.

8. The apparatus as claimed in claim 7, wherein a movement of the first shaft engages the first substrate and the second substrate positioned between the first and second plates to each other.

9. The apparatus as claimed in claim 7, wherein the air suction holes are connected to an air suction device.

10. The apparatus as claimed in claim 9, wherein the air suction device comprises a vacuum pump.

11. A method for sealing an organic light emitting display, comprising:
positioning a first substrate on a positioning plate so as to be overlapped with an elastic member, the positioning plate including an air introduction hole, a plurality of discharge holes, and an elastic member, the plurality of discharge holes communicating with the air introduction hole, and the elastic member being inserted into a groove formed in the positioning plate and arranged to enclose the discharge holes;
arranging a second substrate to be aligned with an upper portion of the first substrate;
forming sealant on at least one of the first and second substrates;
introducing air between the positioning plate and the first substrate through the air introduction hole to maintain a predetermined air pressure;
moving the positioning plate up and down to adhere the first and second substrates to each other; and
irradiating a region corresponding to the sealant to join the first and second substrates to each other.

12. The method as claimed in claim 11, wherein the first substrate includes a pixel region and a non-pixel region formed at a periphery of the pixel region, and the second substrate is arranged to be overlapped with the pixel region and at least a part of the non-pixel region.

13. The method as claimed in claim 12, wherein the sealant is arranged to be overlapped with the non-pixel region.

14. The method as claimed in claim 11, wherein the sealant comprises a frit.

15. The method as claimed in claim 14, further comprising coating, sintering, and curing a frit paste on the second substrate to form the frit, the frit paste including an absorbent adapted to preferentially absorb the irradiation.

16. The method as claimed in claim 15, wherein the frit paste is sintered at a temperature ranging from 300° C. to 700° C.

17. The method as claimed in claim 14, wherein the frit is stuck to the first and second substrates by absorbing the irradiation and melting.

18. The method as claimed in claim 11, wherein a patterned mask is arranged on the second substrate corresponding to the sealant.

19. The method as claimed in claim 11, wherein wavelengths of the irradiation ranges from 800 nm to 1200 nm.

20. An apparatus for engaging two substrates, the apparatus comprising:
a first plate having a substantially planar support surface and adapted to provide a substantially uniform positive pressure across the support surface;
an elastic member arranged about a periphery of the support surface and such that, in a relaxed state, the elastic member extends partially above the support surface and that, under weight of a substrate placed upon the elastic member, the elastic member deforms to provide a pressurized region under the substrate, within the elastic member, and above the support surface;
a second plate having a substantially planar support surface and adapted to provide a substantially uniform negative pressure across the support surface; and
at least a first support shaft engaged with at least one of the first and second support plates such that the at least first support shaft induces the first and second support plates into and away from adjacency with each other.
